(19) United States
(12) Patent Application Publication
(10) Pub. No.: US 2012/0055115 A1
(43) Pub. Date: Mar. 8, 2012

(54) CAPPING HEAD AND APPARATUS FOR THE CAPPING OF BOTTLES

(76) Inventor: Fabrizio Preti, Parma (IT)

(21) Appl. No.: 13/266,965

(22) PCT Filed: May 7, 2009
(86) PCT No.: PCT/EP2009/055534

§ 371 Date: Nov. 28, 2011

(51) Int. Cl. B67B 3/10; B67B 3/22

(52) U.S. Cl. 53/342

(57) ABSTRACT

A capping head (2) for an apparatus (1) for capping containers (4) comprises a first cap fastening assembly, an additional cap fastening assembly (16) configured to fasten a different type of cap to a container aperture, detachable connecting means for detachably connecting the additional cap fastening assembly (16) to the first cap fastening assembly (12) to convert the capping head (2) from a first type of cap to a different type of cap, wherein the detachable connecting means comprise a trap cavity (17) formed in an external surface (18) of the first cap fastening assembly (12) and adapted to receive a corresponding latch member (19) of the additional cap fastening assembly (16) to lock the latter with respect to the capping head (2).

The present invention relates to a device for the capping of containers, in particular bottles.

In the field of bottling plants, capping machines of the revolving type are known which are equipped with a plurality of capping heads and with a plurality of plates for supporting the bottles. The plates and the capping heads revolve in synchrony on the carousel so as to complete the capping cycle along a capping track within a 360° arc of rotation. The operational stages of the capping process may be summarized as follows: the container enters the carousel in synchrony with the capping head which already holds the cap. Specifically, the cap has been previously withdrawn from a cap feeding system and has then been arranged in a centred manner inside the capping head. The capping head, actuated by a cam or by other actuating means, is lowered into contact with the mouth of the container, on which it begins to exert the pressure necessary to secure the cap on the container. The plate on which the bottle is supported can be vertically displaced against the elastic force of a calibrated spring. This calibrated spring compensates height differences of the bottles or containers to be capped and, when the bottle together with the supporting plate are pushed downward by the capping head, the spring exerts a reactive force which guarantees a predetermined and constant capping force irrespective of the height of the container. The capping head is then raised, again by the action of the cam or other suitable actuating means, so as to disengage from the container (leaving the cap attached to it) which can thus leave the capping carousel.

In order to employ the same capping carousel, or more generally, the same capping head for different types of caps or different sizes of caps, it is known to provide a capping head having an integrated first cap fastening assembly adapted to hold, fasten and release a first type of cap (e.g. a crown cap), as well as one or more additional cap fastening assemblies adapted to hold, fasten and release one or more different types of caps (e.g. rip caps or crown caps having shapes or dimensions that differ from the shape or dimensions of the first type).

In accordance with a known solution, each additional cap fastening assembly is screw-connectable to the capping head and comprises an interface portion adapted to be engaged by the first cap fastening assembly in order for the capping movements of the additional cap fastening assembly to be controlled by the movement of the first cap fastening assembly.

However, the conversion of the known capping heads from a first cap (e.g. crown cap) to a different cap (e.g. rip cap) and vice versa requires still too much time and the corresponding screw threads need to be machined with a very high precision which increases the overall cost of the capping machine fabrication and operation.

The object of the present invention is therefore to provide an improved capping head and apparatus for the capping of containers which obviates the above discussed drawbacks of the prior art.

A particular object of the present invention is to provide an improved capping head and apparatus for the capping of containers having a simple and sturdy structure and allowing for a faster but still high precision coupling and alignment of additional cap fastening assembly or assemblies to the capping head.

This object is achieved by a capping head and apparatus for the capping of containers according to the annexed claims.

The features and advantages of the present invention shall be made apparent from the accompanying drawings and the description thereof, which illustrate embodiments of the invention.

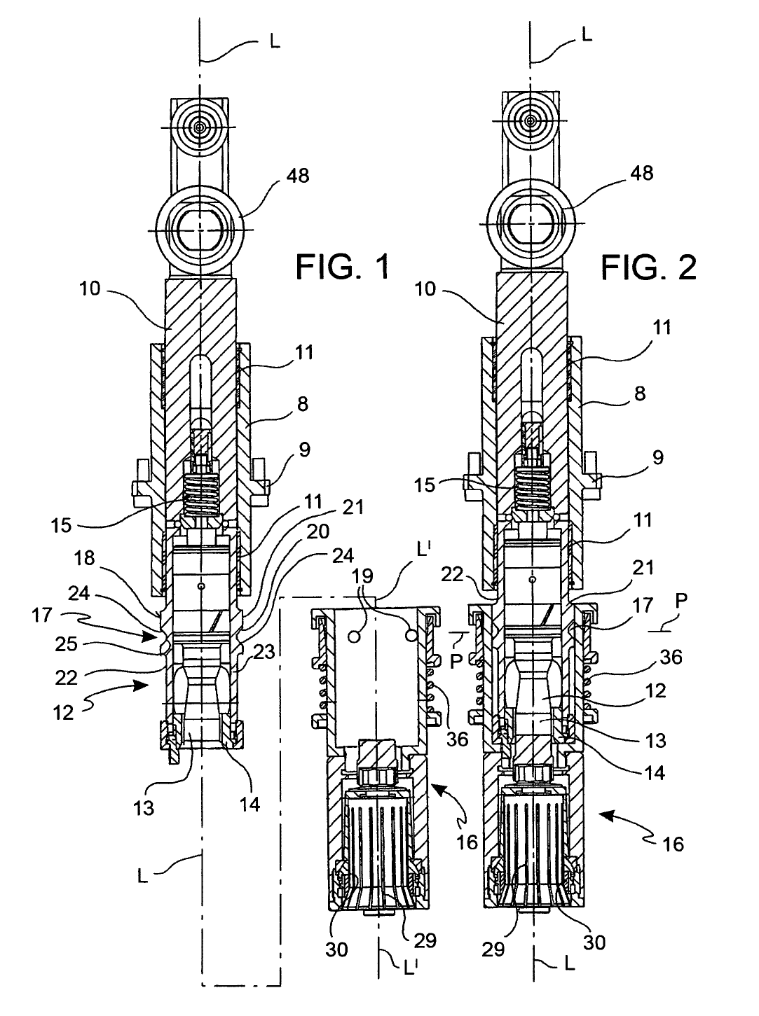

FIG. 1 shows a sectional view of a capping head in a first configuration according to an embodiment of the present invention;

FIG. 2 shows a sectional view of the capping head of FIG. 1 in a further configuration;

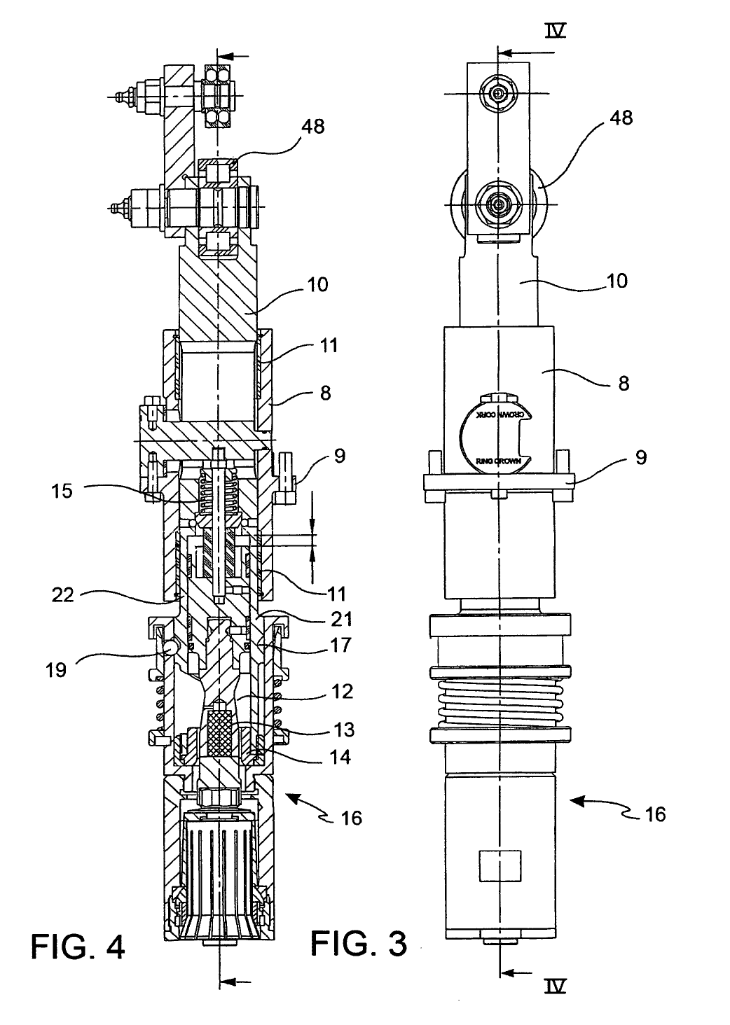

FIG. 3 is a side view of the capping head in FIG. 2;

FIG. 4 is a sectional view according to plane IV-IV in FIG. 3;

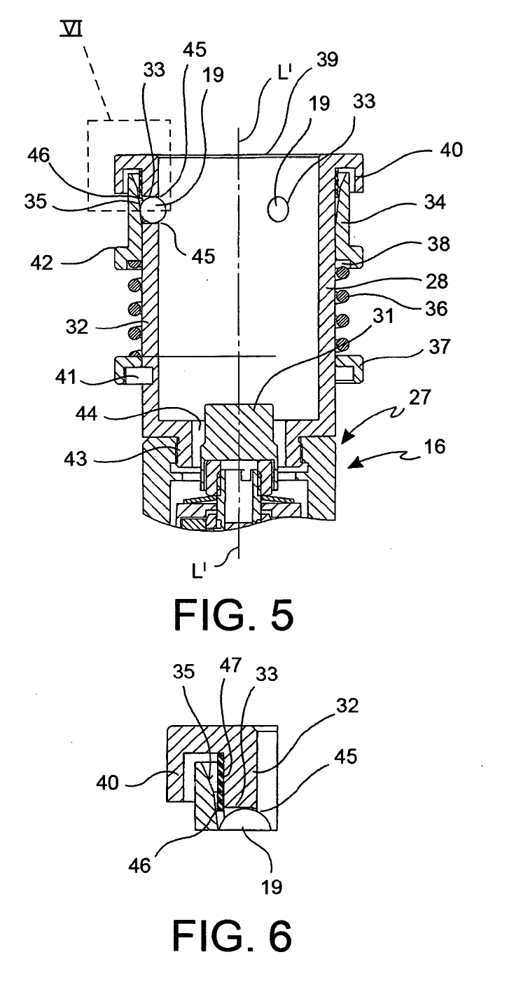

FIG. 5 is a cross-sectional view of a detail of an additional cap fastening assembly of the device according to an embodiment;

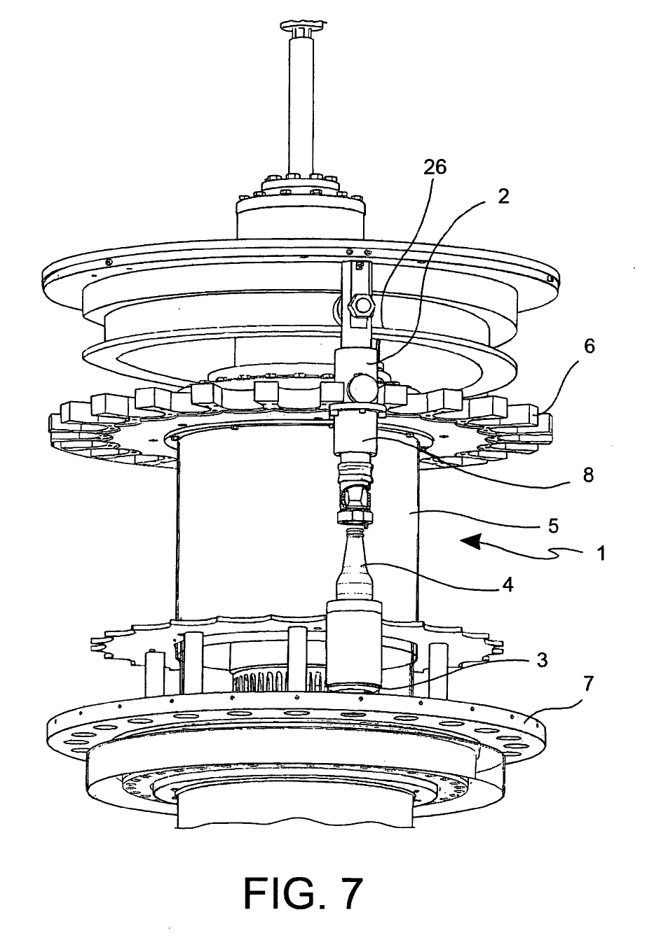

FIG. 6 is an enlarged view of detail VI in FIG. 5;

FIG. 7 illustrates an exemplary embodiment of an apparatus for capping bottles according to the invention.

Referring to the drawings where like numerals denote like components throughout the several views, FIG. 7 depicts an apparatus 1 for capping containers 4. Apparatus 1 comprises a capping head 2 and a plate 3 for supporting the container 4. The capping head 2 and the plate 3 are securely fixed to a carousel 5 by means of respective supports 6, 7 of the carousel 5.

In accordance with an embodiment (as illustrated on FIGS. 1-4), the capping head 2 comprises an outer sleeve 8 with an external connecting flange 9 for screw or bolt connecting the capping head 2 to support 6. A reciprocating piston 10 is slidingly accommodated inside the outer sleeve 8 and guide bushings 11 can be arranged between the outer sleeve 8 and the reciprocating piston in order to reduce the frictional resistance there between and assure a precise guidance of the piston 10.

A first cap fastening assembly 12 is connected to a lower portion (a portion which in use is facing towards the container to be capped) of the reciprocating piston 10 in a manner to move together with the latter.

The first cap fastening assembly 12 comprises a cap holder 13 adapted to receive and hold a (first type of) cap as well as a cap fastener 14 configured to fasten the (first type of) cap held by the cap holder 13 to a container aperture (e.g. a bottle mouth) in response to a actuating movement of the reciprocating piston 10, particularly a downward movement of piston 10 together with the first cap fastening assembly 12 towards and in compressive contact against container 4.

As is known, the first cap fastening assembly 12 can further comprise compensation means 15 configured to compensate container height variations to assure a substantially constant and repeatable pressure with which the cap is pressed against the container 4 during fastening. Such compensation means 15 may comprise one or more elastic springs interposed between the cap holder 13 and/or fastener 14 and a housing of the first cap fastening assembly 12.

In accordance with an embodiment, the first cap fastening assembly 12 is configured to hold a crown cap and to fasten it to a bottle mouth. To this end, the cap holder 13 may comprise magnets at its lower end by means of which the crown cap is retained.

An upper portion of the reciprocating piston 10 opposite the first cap fastening assembly 12 comprises means for operationally connecting the reciprocating piston 10 with an actuating device 26, e.g. a cam follower 48 adapted to abut against a cam track or a connector to a linear motor, configured to move the reciprocating piston 10 towards and away from the container to be capped.

The capping head 2 further comprises detachable connecting means for the detachable connection of an additional cap fastening assembly 16 to the first cap fastening assembly 12, in order to allow conversion of the capping apparatus 1 from a first cap (e.g. a crown cap) to a different cap (e.g. a rip cap).

In accordance with an aspect of the present invention, the connecting means comprise a trap cavity 17 formed in an external surface 18 of a side wall 23 of the housing 22 of the first cap fastening assembly 12 and adapted to receive a corresponding latch member 19 of the additional cap fastening assembly 16 to lock the latter with respect to the capping head 2.

The trap cavity 17 is laterally delimited so that the latch member 19 can enter and exit the trap cavity 17 only in a transversal or perpendicular direction to a longitudinal axis L of the capping head 2. In case of a substantially tubular or cylindrical side wall 23 with a circumferential external surface 18, the trap cavity 17 is thus configured to receive and release the latch member 19 in a substantially radial direction with respect to the longitudinal axis L.

In accordance with an embodiment, the trap cavity 17 forms a circumferentially extending, not necessarily but preferably annular, groove 20 which lies in a plane P perpendicular with respect to the longitudinal axis L of the capping head 2. The groove 20 may be advantageously formed in an only locally thickened wall portion 21 of the housing 22, while the remaining adjacent zones of side wall 23 have a reduced thickness.

Advantageously, the trap cavity 17 comprises at least one, preferably two opposite inclined lateral surfaces 24 which determine a width reduction of the cavity towards a cavity ground 25 and provide centering of the latch member 19 and, hence, of the additional cap fastening assembly 16 with respect to the integrated first cap fastening assembly 12 of the capping head 2.

In accordance with a preferred embodiment, the trap cavity 17 comprises a substantially trapezoidal cross-section, in which the cavity ground 25 forms the minor base, the cavity opening forms the major base and the inclined lateral surfaces 24 form the trapezium sides.

The angle between lateral surfaces 24 and the cavity opening plane can be about 30° to 75°, preferably 45° to 60°, even more preferably about 45°.

The additional cap fastening assembly 16 comprises a housing 27 having a longitudinal axis L′ which in use coincides with the longitudinal axis L of the capping head 2 and a coupling device 28 rigidly connected with or at least partially formed by the housing 27 and configured to detachably couple the additional cap fastening assembly 16 with the capping head 2, particularly with the reciprocating piston 10 or with the housing 22 of the first cap fastening assembly 12.

The additional cap fastening assembly 16 further comprises an additional cap holder 29 adapted to receive and hold a (different type of) cap as well as an additional cap fastener 30 configured to fasten the (different type of) cap held by the additional cap holder 29 to a container aperture (e.g. a bottle mouth) in response to an actuating movement of the reciprocating piston 10, particularly a downward movement of piston 10 together with the additional cap fastening assembly 16 towards and in compressive contact against container 4.

In accordance with an embodiment, the additional type of cap is a rip cap.

To this end, the additional cap fastening assembly 16 can be configured so that, when coupled, its housing 27 is rigidly connected with the housing 27 of the first cap fastening assembly 12 and an actuating portion 31 of the additional cap holder 29 and/or additional cap fastener 30 engages the corresponding cap holder 13 and/or cap fastener 14 so that their movements are operatively linked.

The coupling device 28 comprises a sleeve 32 configured to slidingly receive the housing 22 of the first cap fastening assembly 12 and to coaxially align them to one another and one or more latch members 19, preferably steel balls, arranged in latch seatings 33 of sleeve 32 and movable between a latching position in which the latch members 19 protrude radially inside the sleeve 32 to mesh with trap cavity 17 and a release position in which the latch members 19 protrude radially outside the sleeve 32 and clear the trap cavity 17.

The latch seatings 33 can comprise through holes formed in the side wall of sleeve 32 and shaped to allow the latch members 19 to protrude radially inside the sleeve 32, but to prevent the latch members 19 from falling inside the sleeve 32, e.g. thanks to an internal stop edge 45 which can be embodied by a gradual or stepwise decrease of the width of the latch seatings 33 towards the internal surface of the sleeve side wall.

In order to prevent the latch members 19 from falling out of the seatings 33 towards the outside of the sleeve 32, an external stop edge 46 can be provided at the radially external opening of each seating 33. In order to reduce precise mechanical machining, the external stop edge 46 is preferably embodied by retainer ring 47 which can be inserted over the sleeve 32 and positioned so that it partially overlaps the external latch seating 33 openings. The retainer ring 47 is preferably made of plastic and can be fixed on the external surface of sleeve 32 through heat shrinkage when the ring 47 is fabricated in a heat shrinkable material, or through gluing.

In order to further facilitating the assembling of the additional first cap fastening assembly 12, the retainer ring 47 is positioned in abutment against the end of stroke stop 40 and has a predetermined width such that its external stop edge 46 overlaps the latch seating 33 exactly the desired length (compare FIG. 6).

The coupling device 28 further comprises a locking slider 34 which forms a ramp shaped thrust surface 35 and which is movable between a locking position in which the thrust surface 35 engages the latch members 19 and thrusts them into the latching position and an uncoupling position in which the thrust surface 35 clears the latch members 19 allowing them to move into their release position.

The locking slider 34 may comprise an annular locking slider inserted over the sleeve 32 and movable circumferentially, i.e. rotatable, or axially displaceable between the above said locking position and uncoupling position.

An upper free end 39 of sleeve 32 may form a circumferential, preferably U-shaped cross-section, end of stroke stop 40 against which the locking slider 34 abuts in its locking position, thereby protecting the thrust surface 35 from dust and other dirt harbouring.

Advantageously, the locking slider 34 is permanently elastically biased into the locking position, e.g. by means of a spring 36 arranged between a ring flange 37 fastened to an outer surface of sleeve 32 and a spring seat 38 formed on the external periphery of the sleeve 32.

The ring flange 37 is preferably arranged on a side of the locking slider 34 opposite the upper free end 39 of the sleeve 32.

In order to facilitate the assembling of the additional cap fastening assembly, the ring flange 37 is detachably connected to the sleeve 32, for instance by means of a plurality of pins 41 inserted in corresponding holes in sleeve 32, so that the previously inserted ring flange 37 is biased by spring 36 against pins 41 and the entire group of locking slider 34, spring 36 and ring flange 37 is held between pins 41 and end of stroke stop 40.

As can be seen e.g. in FIGS. 1 and 2, the uncoupling movement of the locking slider 34 takes place in a direction of removal of the additional cap fastening assembly 16 from the first cap fastening assembly 12, so that it becomes possible to unlock the latch members 19 and remove the additional cap fastening assembly 16 by only one single (downward) movement of the locking slider 34.

To improve the grip of the locking slider 34, it may comprise an externally salient edge 42 formed near an end facing in the direction of uncoupling and removal of the additional cap fastening assembly 16. In that case, the spring seat 38 may advantageously be a part of this edge 42.

In accordance with a preferred embodiment, the latch members 19 comprise three steel balls arranged at a 120° angular pitch along a circumference of the sleeve 32 and adapted to engage the trap cavity 17 of the housing 22 of the first cap fastening assembly 12.

The sleeve 32 may further comprise a threaded tubular connector 43 formed at an end of the sleeve 32 opposite the upper free end 39 and adapted to rigidly connect the coupling device 28 with the housing 27 of the additional cap fastening assembly 16. An internal passage 44 enables the first cap holder 13 and/or cap fastener 14 to come into engagement with the actuating portion 31 of the additional cap fastening assembly 16.

As can be immediately appreciated from the foregoing description, the capping head 2 allows an extremely rapid, simple and precise mounting and unmounting of the additional cap fastening assembly 16 during conversion of the capping apparatus 1 from one type of cap (e.g. crown cap) to a different type of cap (e.g. rip cap) and vice versa.

Moreover, the capping head and capping apparatus according to the present inventions allow the connecting portion of the additional cap fastening assembly to be assembled in a very straight forward, simple and precise manner by inserting the latch members 19 from the outside into the latch seatings 33, then inserting the retainer ring 47 over the sleeve 32 and pushing towards the upper free end 39 thereof until it abuts against the end of stroke stop 40, thereby retaining the latch members 19 inside the latch seatings 33, then inserting the locking slider 34, the spring 36 and the ring flange 37 over the sleeve 32 and pushing them towards its upper free end 39, finally fixing the pins 41 on the sleeve 32 to hold the ring flange 37 in its position, so that the spring 36 abuts against the ring flange 37 and biases the locking slider 34 elastically in its locking position.

While the present invention has been illustrated by description of several embodiments and while the illustrative embodiments have been described in considerable detail, it is not the intention to restrict or in any way limit the scope of the appended claims to such detail.

1. Capping head (2) for an apparatus (1) for capping containers (4), comprising:
a first cap fastening assembly (12) having a cap holder (13) adapted to receive and hold a first type of cap and a cap fastener (14) configured to fasten the first type of cap held by the cap holder (13) to an aperture of said container (4),
at least one additional cap fastening assembly (16) having an additional cap holder (29) adapted to receive and hold a second type of cap as well as an additional cap fastener (30) configured to fasten the second type of cap held by the additional cap holder (29) to a container aperture,
detachable connecting means for detachably connecting said additional cap fastening assembly (16) to said first cap fastening assembly (12) to convert said capping head (2) from said first type of cap to said second type of cap, wherein said detachable connecting means comprise:
a trap cavity (17) formed in an external surface (18) of said first cap fastening assembly (12) and adapted to receive a corresponding latch member (19) of said additional cap fastening assembly (16) to lock the latter with respect to the capping head (2).

2. Capping head (2) according to claim 1, wherein said trap cavity (17) is formed in a circumferential external surface (18) of a tubular side wall (23) of said first cap fastening assembly (12) and configured to receive and release the latch member (19) only in a substantially radial direction with respect to the longitudinal axis (L).

3. Capping head (2) according to claim 2, wherein the trap cavity (17) forms a circumferential groove (20) which lies in a plane (P) perpendicular to the longitudinal axis (L) of the capping head (2).

4. Capping head (2) according to claim 2 or 3, wherein said trap cavity (17) is formed in an only locally thickened wall portion (21), while the adjacent zones of side wall (23) have a smaller thickness.

5. Capping head (2) according to claim 1, wherein said trap cavity (17) comprises two opposite inclined lateral surfaces (24) which determine a width reduction of the cavity towards a cavity ground (25) to provide centering of the latch member (19) and of the additional cap fastening assembly (16) with respect to the first cap fastening assembly (12).

6. Capping head (2) according to claim 1, wherein said additional cap fastening assembly (16) comprises a coupling device (28) having a sleeve (32) configured to slidingly receive a part of the first cap fastening assembly (12) and to coaxially align them to one another, wherein said sleeve (32) defines latch seating (33) which hold said latch members (19) movably between a latching position in which the latch members (19) protrude radially inside the sleeve (32) to mesh with said trap cavity (17) and a release position in which said latch members (19) protrude radially outside the sleeve (32) and clear the trap cavity (17).

7. Capping head (2) according to the claim 6, wherein the latch seatings (33) comprise through holes formed in a side wall of sleeve (32) and having an internal stop edge (45) which prevents the latch members (19) from escaping inside the sleeve (32).

8. Capping head (2) according to claim 6, comprising a retainer ring (47) inserted over the sleeve (32) and positioned so that it partially overlaps the external openings of the latch seatings (33), thereby preventing the latch members (19) from escaping outside the sleeve (32).

9. Capping head (2) according to claim 8, wherein said retainer ring (47) is made of heat shrinkable plastic material.

10. Capping head (2) according to claim 8, wherein said retainer ring (47) has a predetermined width and is positioned in abutment against an end of stroke stop (40) of the sleeve (32) such that an external stop edge (46) of retainer ring (47) overlaps the latch seating (33) a desired length.

11. Capping head (2) according to claim 6, wherein the coupling device (28) further comprises a locking slider (34) having a thrust surface (35) and being movable between a locking position in which the thrust surface (35) engages the latch members (19) thrusting them into the latching position, and an uncoupling position in which the thrust surface (35) disengages the latch members (19) allowing them to move into their release position.

12. Capping head (2) according to claim 11, wherein said locking slider (34) is ring-shaped and inserted over the sleeve (32) and an upper free end (39) of sleeve (32) forms an end of stroke stop (40) against which the locking slider (34) abuts in its locking position.

13. Capping head (2) according to claim 11, wherein the locking slider (34) is permanently elastically biased into the locking position by means of a spring (36).

14. Capping head (2) according to claim 11, wherein the uncoupling movement of the locking slider (34) takes place in a direction of removal of the additional cap fastening assembly (16) from the first cap fastening assembly (12), so that only one single movement of the locking slider (34) unlocks the latch members (19) and removes the additional cap fastening assembly (16) from the first cap fastening assembly (12).

15. Capping head (2) according to claim 1, wherein the latch members (19) comprise three steel balls arranged at a 120° angular pitch.

16. Apparatus (1) for capping containers (4) with a first type of cap and at least a further second type of cap, comprising:
at least one container support plate (3) and,
at least one capping head (2),
an actuating device (26) for the movement of the capping head (2) relative to the support plate (3), wherein the capping head (2) comprises:
a first cap fastening assembly (12) having a cap holder (13) adapted to receive and hold a first type of cap and a cap fastener (14) configured to fasten the first type of cap held by the cap holder (13) to an aperture of said container (4),
at least one additional cap fastening assembly (16) having an additional cap holder (29) adapted to receive and hold a second type of cap as well as an additional cap fastener (30) configured to fasten the second type of cap held by the additional cap holder (29) to a container aperture,
detachable connecting means for detachably connecting said additional cap fastening assembly (16) to said first cap fastening assembly (12) to convert said capping head (2) from said first type of cap to said second type of cap, wherein said detachable connecting means comprise:
a trap cavity (17) formed in an external surface (18) of said first cap fastening assembly (12) and adapted to receive a corresponding latch member (19) of said additional cap fastening assembly (16) to lock the latter with respect to the capping head (2).

17. Capping head (2) according to claim 7, comprising a retainer ring (47) inserted over the sleeve (32) and positioned so that it partially overlaps the external openings of the latch seatings (33), thereby preventing the latch members (19) from escaping outside the sleeve (32).

18. Capping head (2) according to claim 9, wherein said retainer ring (47) has a predetermined width and is positioned in abutment against an end of stroke stop (40) of the sleeve (32) such that an external stop edge (46) of retainer ring (47) overlaps the latch seating (33) a desired length.

19. Capping head (2) according to claim 12, wherein the uncoupling movement of the locking slider (34) takes place in a direction of removal of the additional cap fastening assembly (16) from the first cap fastening assembly (12), so that only one single movement of the locking slider (34) unlocks the latch members (19) and removes the additional cap fastening assembly (16) from the first cap fastening assembly (12).
